(19) United States
(12) Patent Application Publication
(10) Pub. No.: US 2005/0044416 A1
(43) Pub. Date: Feb. 24, 2005

(54) Controlling of devices according to model type of a controlling device

(76) Inventor: Ayako Kobayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/878,385

(22) Filed: Jun. 29, 2004

(30) Foreign Application Priority Data
Jun. 30, 2003 (JP) 2003-187692
Jun. 16, 2004 (JP) 2004-178295

(51) Int. Cl. G06F 9/00

(52) U.S. Cl. 713/201

(57) ABSTRACT

An information processing device in which one or more programs use one or more devices includes a device controlling unit linkable to the one or more programs and configured to read one or more setting files containing model-type-dependent information provided separately for one or more model types and to control the one or more devices in response to a request from the one or more programs in accordance with the model-type-dependent information corresponding to a model type of the information processing device.

### BACKGROUND OF THE INVENTION

1. Field of the Invention

The present invention generally relates to information processing devices, device control methods, and record media, and particularly relates to an information processing device in which one or more programs use one or more devices, a device control method of controlling one or more devices, and a record medium storing a program for such a device control method.

2. Description of the Related Art

In recent years, the use of information processing devices has become prevalent in various application fields. In such information processing devices, nonvolatile memory devices such as NVRAMs (NonVolatile Random Access Memories) and hard disk drives store information that should not be erased after power is turned off. An NVRAM, for example, includes a built-in EEPROM (Electrically Erasable Programmable Read Only Memory) or flash RAM together with a conventional RAM. In an NVRAM, when the power supply voltage is lowered below a predetermined level, the contents of the RAM are copied to the ROM. When the power supply voltage is raised above the predetermined level, the contents stored in the ROM are copied to the RAM. This ensures that the stored information is not erased at the time of power-off.

In such information processing devices as image processing devices, information that should not be erased at power-off, e.g., billing information, user settings, error history, etc., is stored in an NVRAM. In conventional image-processing devices, a device such as an NVRAM is controlled by use of various device control methods.

One of the related-art device control methods divides the memory area of an NVRAM according to intended usages. With this device control method, area allocation information (e.g., offset, size, etc.) about divided areas allocated according to their usages may differ depending on the model types of image-processing devices. Because of this, area allocation information about divided areas allocated according to their usages need to be specified separately for every model type of image-processing devices.

In consideration of this, some related-art device control method specifies area allocation information as model-type-specific settings for respective image-processing devices, and stores these settings for a plurality of model types in the NVRAM control program for controlling an NVRAM. Such device control method searches in the NVRAM control program to find setting information corresponding to the particular model of an image-processing device that uses the NVRAM, and controls the NVRAM according to the retrieved setting information.

Japanese Patent Application Publication No. 2000-141830 discloses an example of a technology for accessing information stored in an NVRAM. Japanese Patent Application Publication No. 2002-149015 discloses an example of a technology for accessing a nonvolatile memory by utilizing model-type-specific configuration data where such configuration data is provided for a plurality of model types.

In the related-art device control methods, model-type-specific settings for respective image-processing devices are contained in the header file of an NVRAM control program. FIG. 1 is an illustrative drawing for explaining a location where setting information is stored in a NVRAM control program.

In this manner, the related-art device control methods use setting information stored in an NVRAM control program. Because of such construction, the header file of a NVRAM control program needs to be updated to include setting information for different or new model types, and needs to be compiled and linked to generate a new object code of the NVRAM control program. This is the case even when information-processing devices are the same kind such as the image-processing device. That is, when a different or new information-processing device is to be used, the header file and the object file need to be modified and remade, resulting in an excess time and costs.

When an NVRAM control program is provided as a library, for example, the related-art device control method needs to add setting information about a new model type to the library source code in order to make the library applicable to the new model type. The related-art device control method then needs to compile the source code and to link relevant programs to the library. This is cumbersome work, and is not desirable. Moreover, the conventional device control methods control only one type of a device as the storage for storing information that should not be erased at power-off. Operability is thus unsatisfactory, and safety measures are not sufficient against the erasure of information.

Accordingly, there is a need for a device control method that makes it possible to readily cope with a different or new model type, and provides good operability and high-level safety. There are also needs for an information-processing device based on such a device control method and a record medium storing such a device control method therein.

### SUMMARY OF THE INVENTION

It is a general object of the present invention to provide an information-processing device, a device control method, and a record medium that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an information-processing device, a device control method, and a record medium particularly pointed out in the specification in such full, clear, concise, and exact terms as to enable a person having ordinary skill in the art to practice the invention.

To achieve these and other advantages in accordance with the purpose of the invention, the invention provides an information processing device in which one or more programs use one or more devices, the information processing device including a device controlling unit that is linkable to the one or more programs and that is configured to read one or more setting files containing model-type-dependent information provided separately for one or more model types and to control the one or more devices in response to a request from the one or more programs in accordance with the model-type-dependent information corresponding to a model type of the information processing device.

According to another aspect of the invention, a method of controlling one or more devices in an information processing device in which one or more programs use the one or more devices includes the steps of utilizing a device controlling unit linkable to the one or more programs to read one or more setting files containing model-type-dependent information provided separately for one or more model types, and utilizing the device controlling unit to control the one or more devices in response to a request from the one or more programs in accordance with the model-type-dependent information corresponding to a model type of the information processing device.

According to another aspect of the invention, a computer-readable medium has a program embodied therein for causing a computer to control one or more devices, the program including a device controlling unit that is linkable to one or more programs and that is configured to read one or more setting files containing model-type-dependent information provided separately for one or more model types and to control the one or more devices in response to a request from the one or more programs in accordance with the model-type-dependent information corresponding to a model type of the information processing device.

According to at least one embodiment of the invention, model-type-dependent information is provided as one or more setting files, thereby achieving the sharing of a device controlling unit and making it possible to control one or more devices in the manner conforming to a different or new model type by simply modifying the model-type-dependent information contained in the one or more setting files. This provides an information processing device, a device controlling method, and a memory medium storing a device controlling method that readily cope with a different or new model type, and that provide good operability and high-level safety.

### BRIEF DESCRIPTION OF THE DRAWINGS

Other objects and further features of the present invention will be apparent from the following detailed description when read in conjunction with the accompanying drawings, in which:

FIG. 1 is an illustrative drawing for explaining a location where setting information is stored in a NVRAM control program;

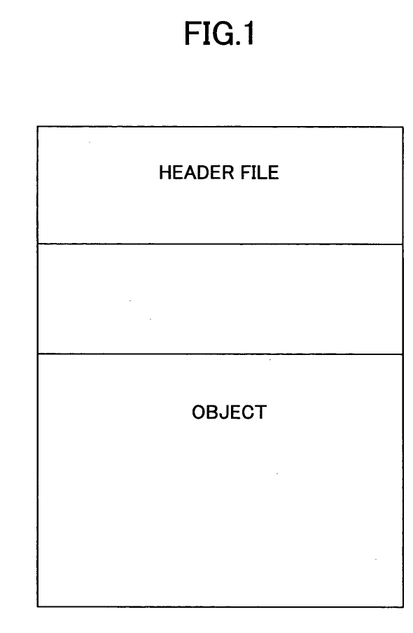

FIG. 2 is a block diagram showing the hardware construction of an example of an information-processing device according to the present invention;

FIG. 3 is an illustrative drawing for explaining an example of a device control method according to the invention;

FIG. 4 is an illustrative drawing showing an example of a memory map in which divided areas are allocated to respective intended end-usages;

FIG. 5 is an illustrative drawing showing an example of a setting file that is used when an HDD area is divided according to usages;

FIG. 6 is an illustrative drawing showing an example of a setting file that is used when an SD-card area is divided according to usages;

FIG. 7 is an illustrative drawing showing an example of a setting file that is used when an NVRAM area is divided according to usages;

FIG. 8 is a flowchart showing an example of a process that is performed by a device control library to read a setting file;

FIG. 9 is a flowchart showing an example of a device accessing process performed by utilizing the device control library;

FIG. 10 is a flowchart of an example of a device selection process;

FIG. 11 is an illustrative drawing showing an example of a device selection screen;

FIG. 12 is an illustrative drawing showing an example of a setting file that is used when the device selection process is performed;

FIG. 13 is an illustrative drawing showing an example of a setting file that is used to improve the safety of information stored in a device;

FIG. 14 is an illustrative drawing showing an example of a setting file usable for a plurality of controller boards;

FIG. 15 is an illustrative drawing showing an example of a setting file in which model-type-dependent information is divided into separate descriptions contained in a plurality of respective files;

FIG. 16 is an illustrative drawing showing another example of a setting file in which model-type-dependent information is divided into separate descriptions;

FIG. 17 is a flowchart showing an example of a process carried out by the device control library to read a setting file;

FIG. 18 is an illustrative drawing showing an example of a setting file that is used when model-type-dependent files are acquired from a server;

FIG. 19 is an illustrative drawing showing another example of a setting file in which model-type-dependent information is divided into separate descriptions contained in respective files; and

FIG. 20 is a flowchart showing another example of a process carried out by the device control library to read a setting file.

### DESCRIPTION OF THE PREFERRED EMBODIMENTS

In the following, embodiments of the present invention will be described with reference to the accompanying drawings.

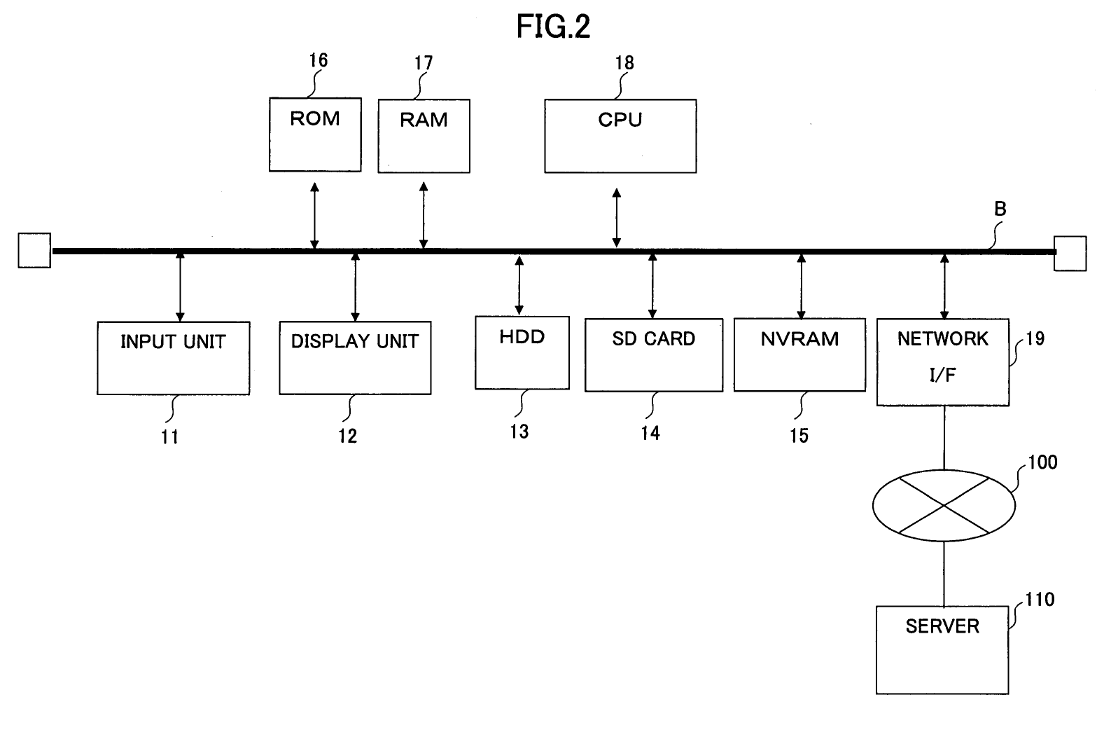

FIG. 2 is a block diagram showing the hardware construction of an example of an information-processing device according to the present invention. The information-processing device of FIG. 2 has a control board which carries or is connected to an input unit 11, a display unit 12, a hard-disk drive unit (HDD) 13, an SD (Secure Digital) card 14, an NVRAM 15, a ROM 16, a RAM 17, a CPU18, and a network I/F 19, all of which are connected together through a bus B.

The input unit 11 is comprised of a keyboard, a mouse, etc., and is used to enter various operator instructions. The display unit 12 is comprised of a display, etc., and presents various types of windows, data, etc., which are necessary for operator instructions. The network I/F 19 provides a connection withy a server 110 through a network 100 such as the Internet or a LAN (local area network), and acquires a program, data, etc., from the server 110 as such a need arises.

The ROM 16 stores programs, data, etc. The RAM 17 operates as a main memory of the CPU 18. The CPU 18 executes various processes according to programs stored in the ROM 16 or the like. Moreover, the CPU 18 attends to overall control of the information-processing device.

The HDD 13, the SD card 14, and the NVRAM 15 store therein various information for use by the information-processing device, and such information is retrieved in response to an instruction from the CPU 18. The information stored in the HDD 13, the SD card 14, and the NVRAM 15 is not erased, but is retained even when power is turned off. It follows that the HDD 13, the SD card 14, and the NVRAM 15 are generally used to store information that should not be erased at power-off.

The HDD 13 and the SD card 14 may be configured to include a resident area. The NVRAM 15 may be configured to include a resident area and an option area.

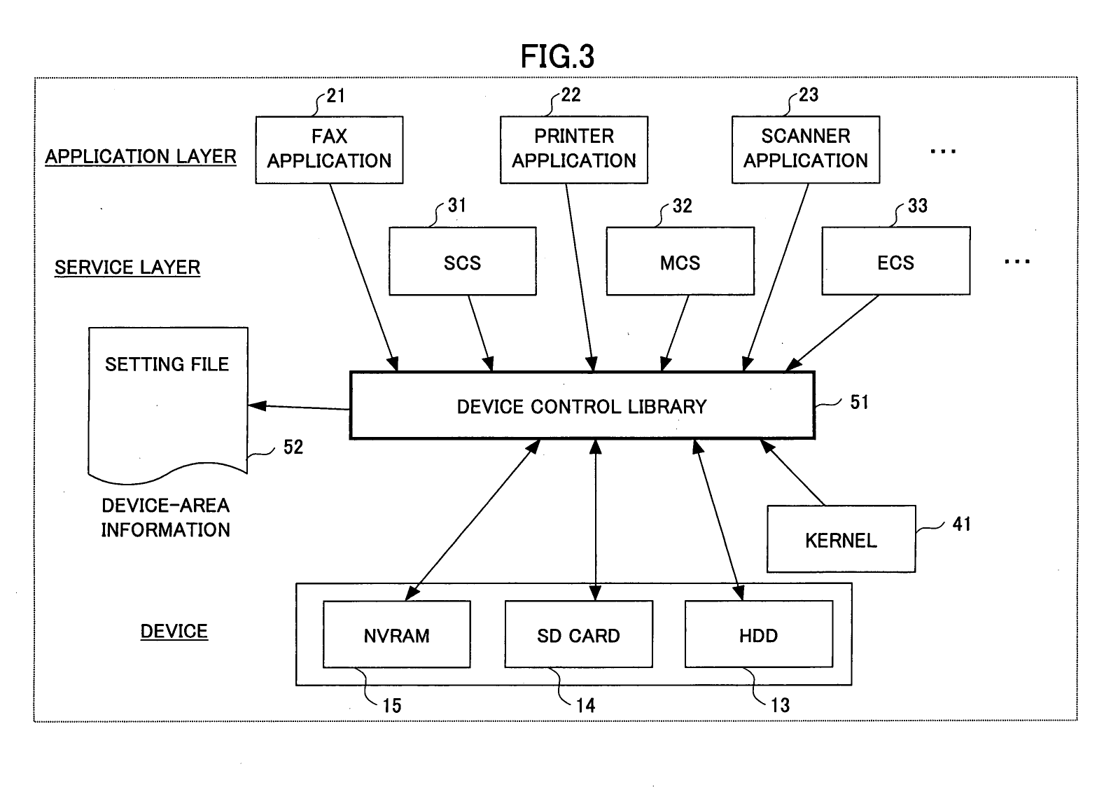

The CPU 18 executes programs stored in the ROM 16 or the like as processes on an OS. The processes running on the OS access the HDD 13, the SD card 14, and the NVRAM 15, as will be described with reference to FIG. 3.

FIG. 3 is an illustrative drawing for explaining an example of the device control method according to the invention. In the following, a description will be given of an image-processing device taken as an example of an information-processing device. Japanese Patent Application Publication No. 2002-84383 discloses an example of an image-processing device that is provided with the functions of a printer, a copier, a facsimile device, and a scanner contained in a single housing. This image-processing device includes a display unit, a printer unit, an imaging unit, etc., in the housing, and is provided with the four types of software programs corresponding to a printer, a copier, a facsimile device, and a scanner. These software programs are switched to let the device operate as a printer, a copier, a facsimile device, or a scanner.

In the image-processing device of FIG. 3, application-layer programs and service-layer programs run as processes on the OS. The application-layer programs include a fax application 21, a printer application 22, a scanner application 23, etc., which perform processing relating to the forming of images. The service-layer programs include an SCS (system control service) 31, an MCS (memory control service) 32, an ECS (engine control service) 33, etc., which issue a request for the use of hardware resources by analyzing a processing request coming from the application layer.

When a process running on the OS accesses a device such as the HDD 13, the SD card 14, and the NVRAM15, such access is made by calling a function stored in a device control library 51 that exemplifies a device control means. The device control library 51 reads a setting file 52, which will be described later, and accesses the device according to a description provided in the setting file 52. The device control library 51 and the setting file 52 are stored in the ROM 16, for example.

In the following, a detailed description will be given of the device control library 51 and the setting file 52 according to the invention. Here, the HDD 13, the SD card 14, and the NVRAM 15 are taken as an example of a device, and a description will be given of a case in which the areas of these memories are divided according to the usages.

[First Embodiment]

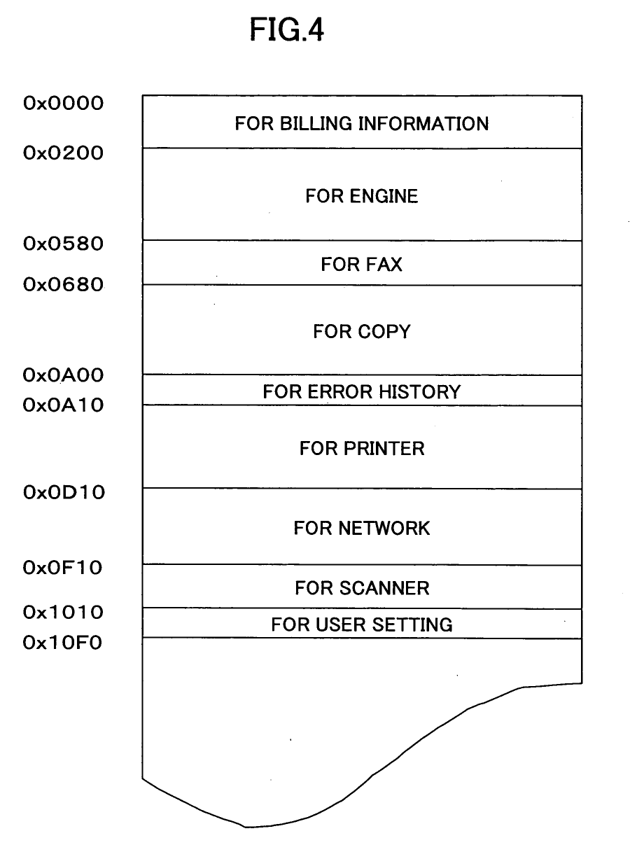

FIG. 4 is an illustrative drawing showing an example of a memory map in which divided areas are allocated to the respective intended end-usages. In the memory map shown in FIG. 4, the divided areas are allocated for the billing information purpose, the engine purpose, etc., on a usage-specific basis. In the memory map of FIG. 4, for example, an area from 0x0000 to 0x0200 is assigned to the billing information purpose. In the following, a description will be given of a setting file that is used when the area of a device such as the HDD 13, the SD card 14, or the NVRAM 15 is divided as in the memory map of FIG. 4.

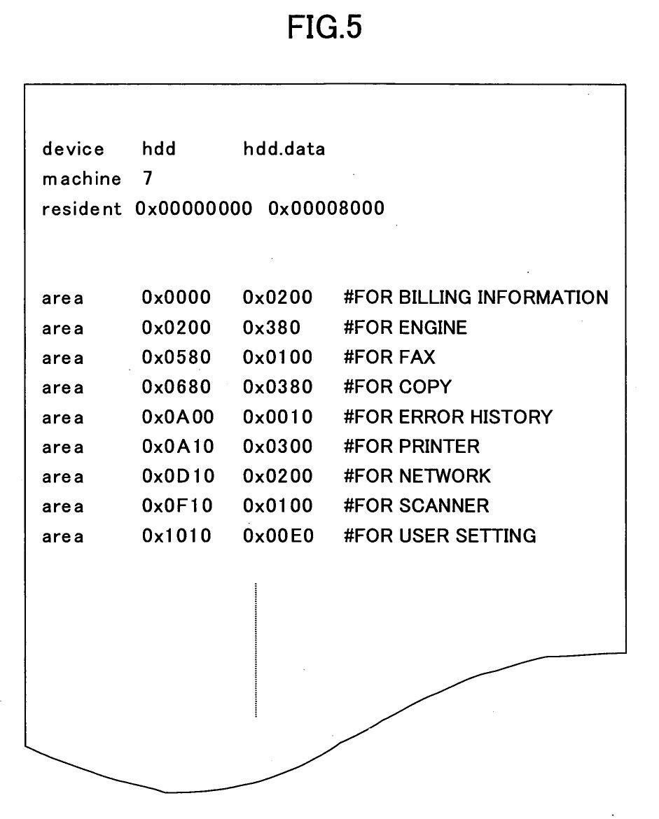

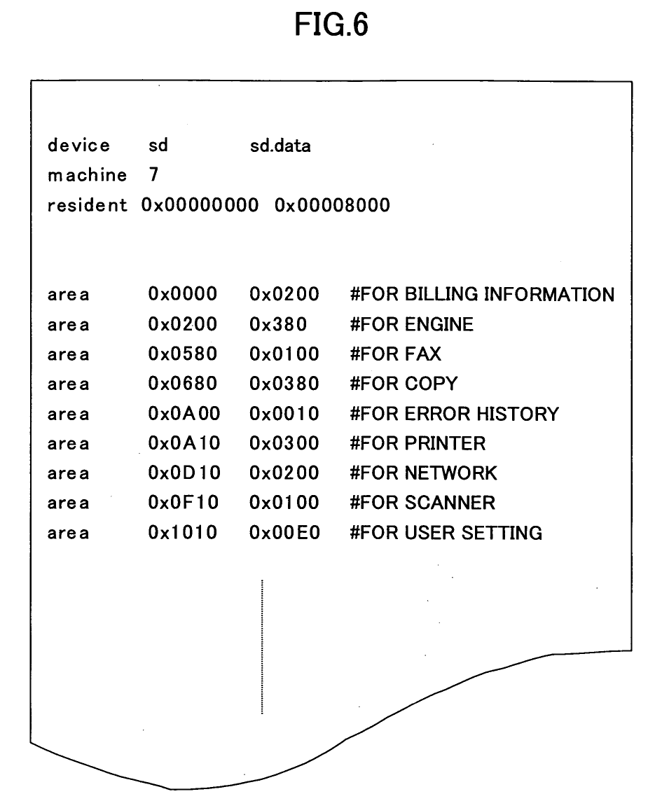

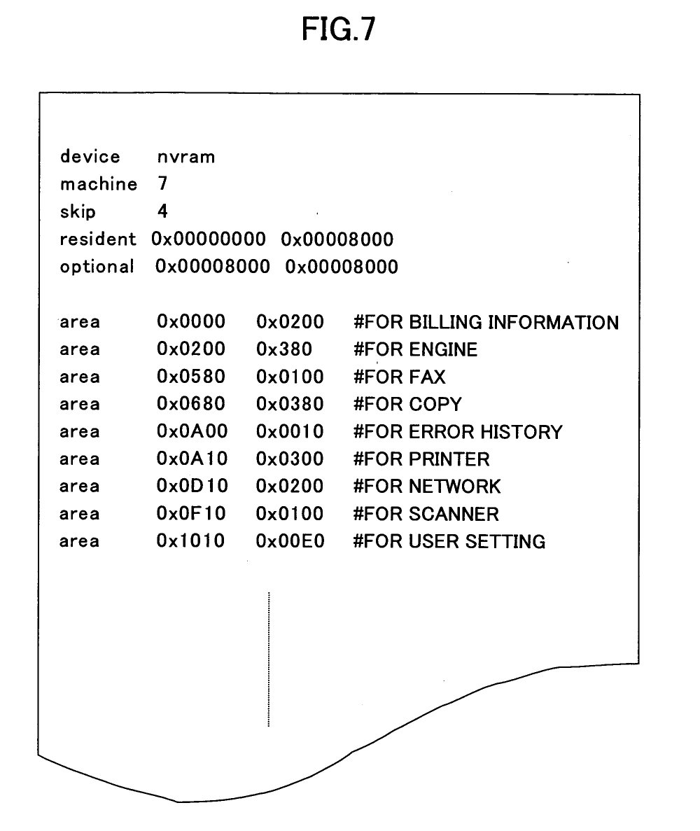

FIG. 5 is an illustrative drawing showing an example of a setting file that is used when the HDD area is divided according to usages. FIG. 6 is an illustrative drawing showing an example of a setting file that is used when the SD-card area is divided according to usages. FIG. 7 is an illustrative drawing showing an example of a setting file that is used when the NVRAM area is divided according to usages. The setting files of FIG. 5 through FIG. 7 include one command together with one or more associated parameters per line.

The setting file of FIG. 5 will be described first. The first line of the setting file is a device command, which has a first parameter that specifies the HDD 13 as a device whose area is divided according to usages. Since the HDD 13 is accessed through a file, this file is specified by the second parameter of the device command.

The second line is a machine command, which includes model-type information for identifying a model type such as a controller-board type. The third line is a resident command, which specifies the resident area of the HDD 13 (hereinafter referred to as a resident HDD area) by an offset from the start address and its size. The resident command includes a first parameter for indicating the offset of the resident HDD area from the start address, and further includes a second parameter for indicating its size.

Fourth through twelfth lines are area commands, which specify the respective usage-specific divided areas of the HDD 13 by offsets from the start address of the HDD 13 and their sizes. An area command includes a first parameter for indicating an offset from the start address of the HDD 13, and further includes a second parameter for indicating the size. Further, the area command may include a parameter for indicating area identification information that serves to identify a corresponding area of the HDD 13 among areas divided according to usages.

The machine command, the resident command, and the area commands together constitute model-type-dependent information for one model type. The setting file of FIG. 5 contains a description of the model-type-dependent information for one model type. Alternatively, model-type-dependent information for more than one model type may be described in the setting file.

In the following, the setting file of FIG. 6 will be described. The first line of the setting file is a device command, which has a first parameter that specifies the SD card 14 as a device whose area is divided according to usages. Since the SD card 14 is accessed through a file, this file is specified by the second parameter of the device command.

The second line is a machine command, which includes model-type information for identifying a model type such as a controller-board type. The third line is a resident command, which specifies the resident area of the SD card 14 (hereinafter referred to as a resident SD-card area) by an offset from the start address and its size. The resident command includes a first parameter for indicating the offset from the start address of a file laid out in memory space, and further includes a second parameter for indicating its size.

Fourth through twelfth lines are area commands, which specify the respective usage-specific divided areas of the SD card 14 by the offsets from the start address of files laid out in memory space and their sizes. An area command includes a first parameter for indicating the offset from the start address of a file laid out in memory space, and further includes a second parameter for indicating its size. Further, the area command may include a parameter for indicating area identification information that serves to identify a corresponding area of the SD card 14 among areas divided according to usages.

The machine command, the resident command, and the area commands together constitute model-type-dependent information for one model type. The setting file of FIG. 6 contains a description of the model-type-dependent information for one model type. Alternatively, model-type-dependent information for more than one model type may be described in the setting file.

In the following, the setting file of FIG. 7 will be described. The first line of the setting file is a device command, which has a first parameter that specifies the NVRAM 15 as a device whose area is divided according to usages.

The second line is a machine command, which includes model-type information for identifying a model type such as a controller-board type. The third line is a skip command, which specifies the type of bus connection indicating how the NVRAM 15 is connected to the bus B.

The fourth line is a resident command, which specifies the resident area of the NVRAM 15 (hereinafter referred to as a resident NVRAM area) by an offset from the start address and its size. The resident command includes a first parameter for indicating the offset of the resident NVRAM area from the start address, and further includes a second parameter for indicating its size.

The fifth line is an optional command, which specifies the optional area of the NVRAM 15 (hereinafter referred to as an optional NVRAM area) by an offset from the start address and its size. The optional command includes a first parameter for indicating the offset of the optional NVRAM area from the start address, and further includes a second parameter for indicating its size.

Sixth through fourteenth lines are area commands, which specify the respective usage-specific divided areas of the NVRAM 15 by offsets from the start address of the NVRAM 15 and their sizes. An area command includes a first parameter for indicating an offset from the start address of the NVRAM 15, and further includes a second parameter for indicating the size. Further, the area command may include a parameter for indicating area identification information that serves to identify a corresponding area of the NVRAM 15 among areas divided according to usages.

The machine command, the skip command, the resident command, the optional command, and the area commands together constitute model-type-dependent information for one model type. The setting file of FIG. 7 contains a description of the model-type-dependent information for one model type. Alternatively, model-type-dependent information for more than one model type may be described in the setting file.

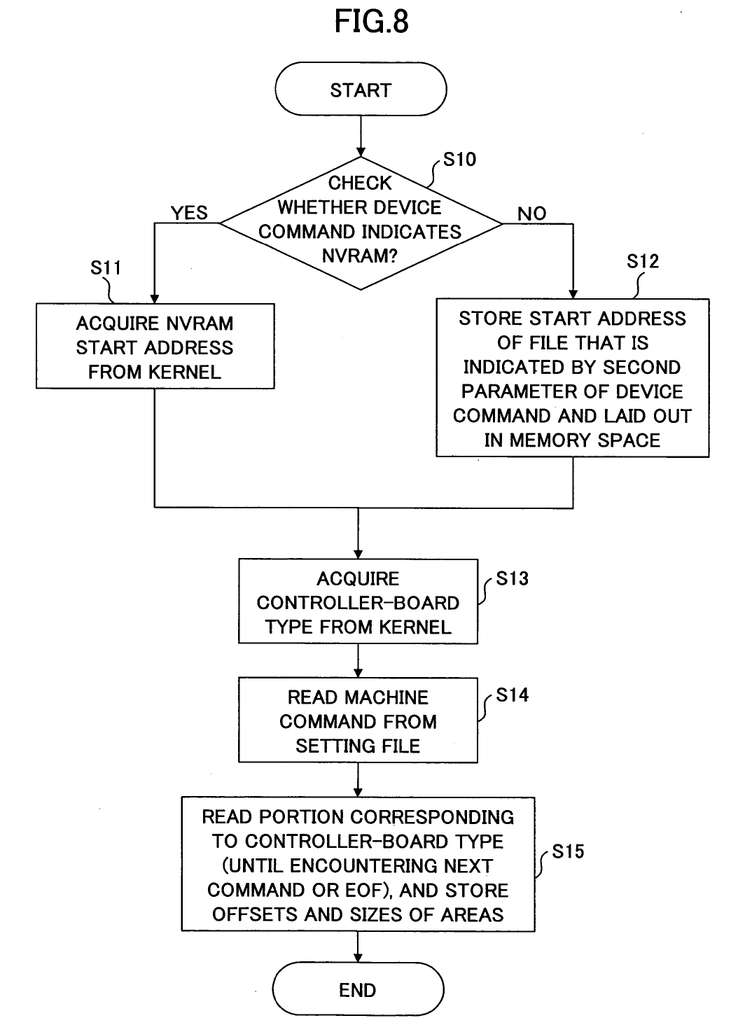

In the following, a description will be given of a process whereby the device control library reads the setting file as described above. FIG. 8 is a flowchart showing an example of a process that is performed by the device control library to read a setting file. The setting-file reading process of FIG. 8 may be carried out at the power-on of an image-processing device.

At step S10, the device control library 51 checks whether the device command indicates the NVRAM 15. If the device command indicates the NVRAM 15 (YES at S10), the device control library 51 moves to step S11 and obtains a start address of the NVRAM 15 from an OS kernel 41.

If step S10 finds that the device command does not indicate the NVRAM 15 (NO at step S10), the device control library 51 moves to step S12 and lays out in the RAM 17 the file indicated by the second parameter of the device command, followed by storing the start address of the file.

At step S13 following step S11 or S12, the device control library 51 obtains model-type information from the kernel 41 where the model-type information indicates a controller-board type of the image-processing device. At step S14, the device control library 51 reads machine commands from the setting file. At step S15, the device control library 51 searches among the machine commands read at step S14 to find a machine command indicative of the same model-type information as the model-type information obtained at step S13. After finding the machine command indicative of the same model-type information, the device control library 51 retrieves model-type-dependent information corresponding to the same model-type information, and stores the retrieved model-dependent information.

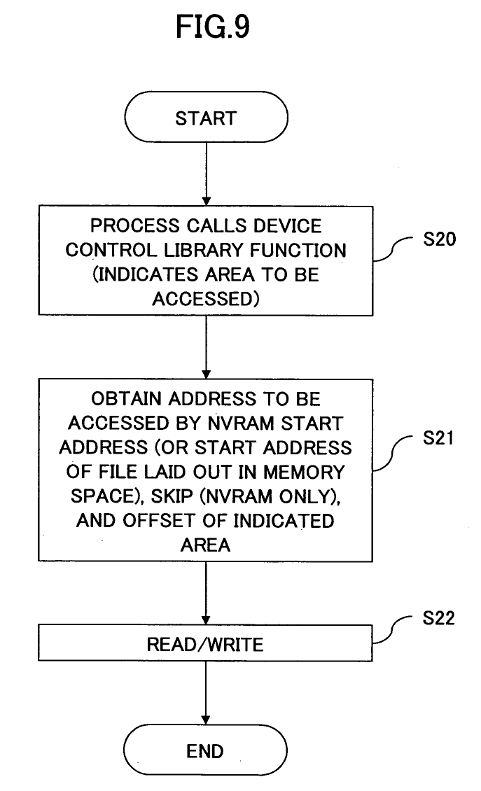

In what follows, a description will be given of, with reference to FIG. 9, a process performed by a process running on the OS to access a device such as the HDD 13, the SD card 14, or the NVRAM 15 by reading the function of the device control library 51.

FIG. 9 is a flowchart showing an example of a device accessing process performed by utilizing the device control library. When access to a device such as the HDD 13, the SD card 14, or the NVRAM 15 becomes necessary, a process running on the OS calls the function of the device control library 51 at step S20. In so doing, the process specifies the area identification information indicative of the area to which access is to be made.

At step S21, the device control library 51 obtains an address to be accessed by using the model-type-dependent information stored at step S15 and the start address of the device such as the NVRAM 15 or a file laid out in memory space. Specifically, the device control library 51 obtains an address to be accessed based on the start address of the device such as the NVRAM 15 and an offset of an area specified by the area identification information. It should be noted that, in the case of the NVRAM 15, the device control library 51 obtains an address to be accessed based on the start address of the device such as the NVRAM 15, an offset of an area specified by the area identification information, and information specified by the skip command.

At step S22, the device control library 51 accesses the device such as the HDD 13, the SD card 14, or the NVRAM 15 by using the address to be accessed that was obtained at step S21.

In the device control method according to at least one embodiment of the invention as described above, device-dependent information is removed from the device control library 51, and is provided as a description in the setting file 52 separate from the device control library 51. All that is necessary to allow the device control library 51 to cope with a different or new model type is to modify the setting file 52. Namely, a plurality of model types can use the same device control library 51.

[Second Embodiment]

In the first embodiment, the device to be accessed by a process needs to be specified beforehand in the setting file as a device command. The second embodiment, on the other hand, is directed to a device control method in which a device to be accessed is selectable by an operator.

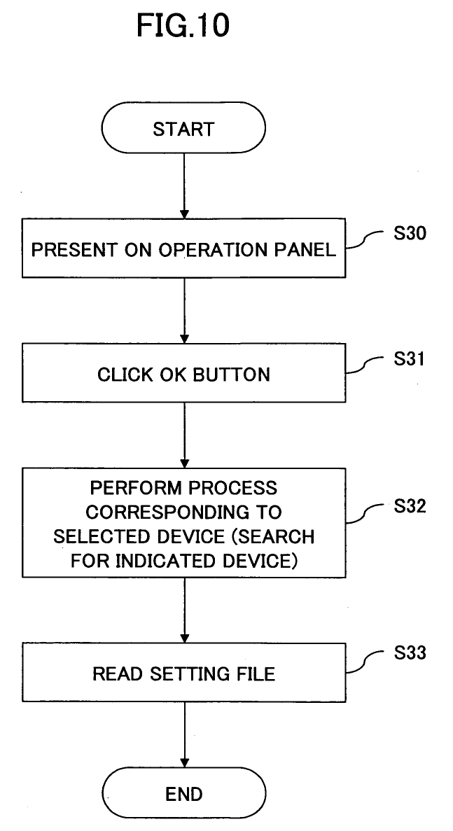

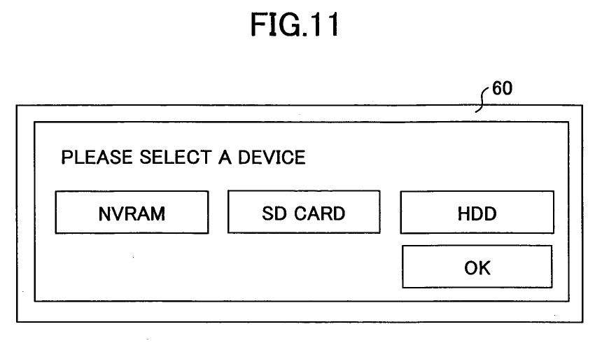

FIG. 10 is a flowchart of an example of a device selection process. The device selection process of FIG. 10 may be carried out at the power-on of an image-processing device. At step S30, the device control library 51 uses the OCS (operation panel control service) running as a process in the service layer to present a device selection screen 60 as shown in FIG. 11 on the operation panel.

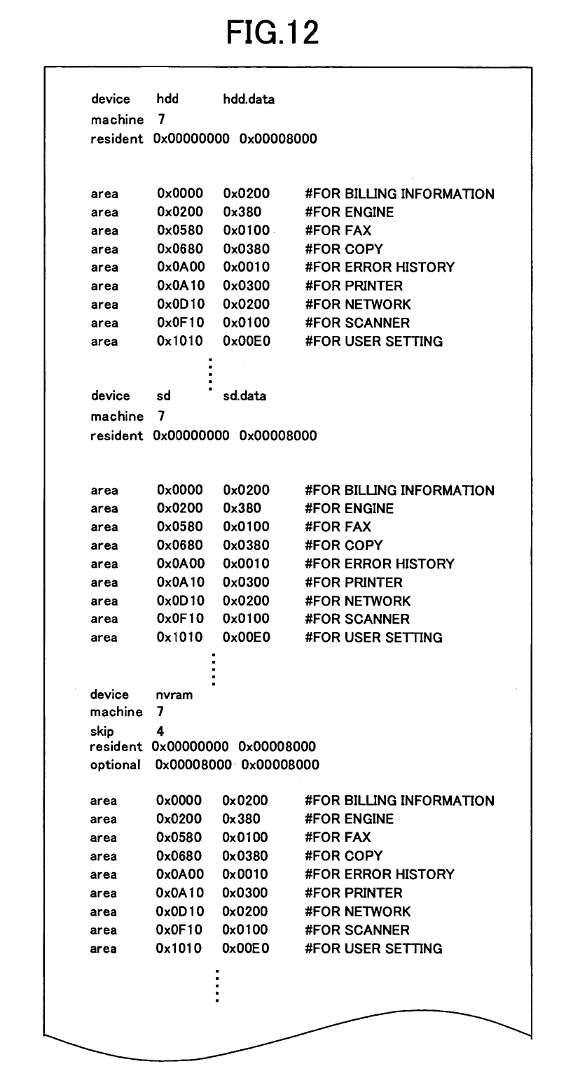

FIG. 11 is an illustrative drawing showing an example of the device selection screen. The device selection screen 60 of FIG. 11 includes buttons for selecting a device to be accessed among the HDD 13, the SD card 14, and the NVRAM 15. The types of devices presented on the device selection screen 60 are determined by the device commands of a setting file as shown in FIG. 12.

FIG. 12 is an illustrative drawing showing an example of a setting file that is used when the device selection process is performed. The setting file of FIG. 12 includes one command together with one or more associated parameters per line.

The setting file of FIG. 12 is configured to include in a single setting file all the descriptions provided in a plurality of setting files as shown in FIG. 5 through FIG. 7. Namely, the setting file of FIG. 12 includes descriptions of model-type-dependent information for a plurality of device types. The device control library 51 reads devices specified by the device commands from the setting file of FIG. 12, and presents the buttons for selecting these devices on the device selection screen 60.

The operator clicks a button for selecting the HDD 13, the SD card 14, or the NVRAM 15 on the device selection screen 60, thereby choosing a device to be accessed. At step S31, the operator clicks the OK button on the device selection screen 60, resulting in the device control library 51 acquiring the selected device from the OCS.

At step S32, the device control library 51 searches in the setting file of FIG. 12 for the model-type-dependent information of the selected device by use of the first parameter of the device command. At step S33, the device control library 51 carries out a setting-file reading process as shown in FIG. 8.

In the device control method according to at least one embodiment of the invention as described above, model-type-dependent information about all the devices selectable by an operator is described in the setting file. This provision allows the operator to select a device to be accessed, and lets the device control library 51 handle the selected device.

[Third Embodiment]

In the third embodiment, a description will be given of a device control method that improves the safety of information stored in a device. In this example, the NVRAM 15 is employed as a device to be accessed.

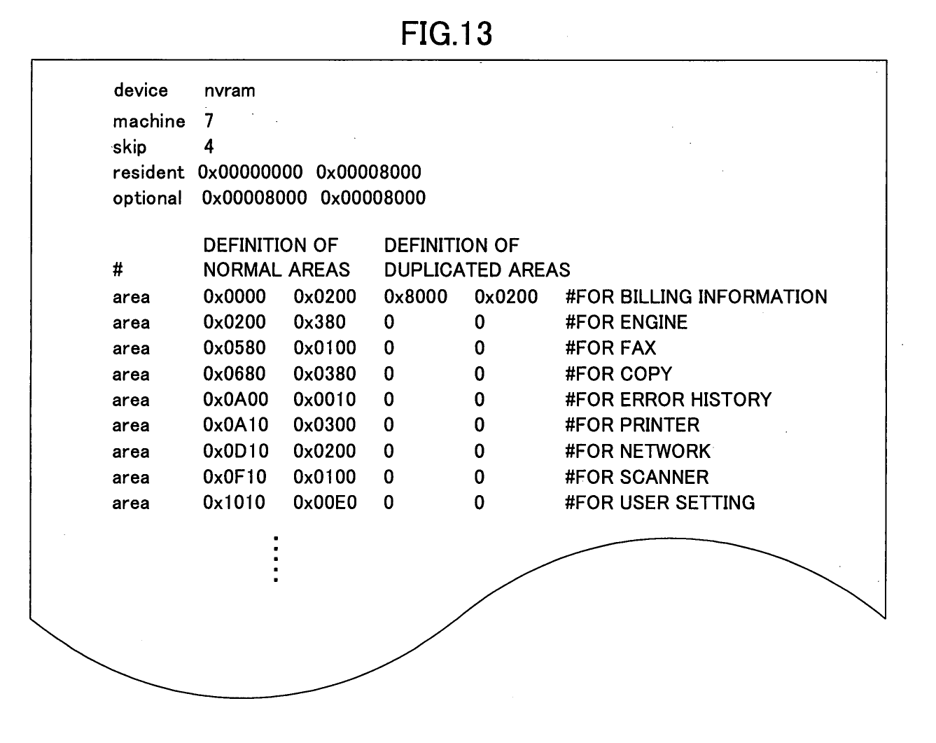

FIG. 13 is an illustrative drawing showing an example of a setting file that is used to improve the safety of information stored in a device. The setting file of FIG. 13 includes one command together with one or more associated parameters per line. The first through fifth lines of the setting file of FIG. 13 are the same as the first through fifth lines of the setting file of FIG. 7, and a description thereof will be omitted.

Seventh through fifteenth lines are area commands, which specify respective normal areas and duplicated areas with respect to the usage-specific divided areas of the NVRAM 15. Specifically, an area command indicates a normal area and a duplicated area by use of respective offsets from the start address of the NVRAM 15 and their respective sizes

An area command has a first parameter for indicating an offset defining a normal area, a second parameter for indicating the size of the normal area, a third parameter for indicating an offset defining a duplicated area, and a fourth parameter for indicating the size of the duplicated area.

When writing information in the NVRAM 15, the device control library 51 having read the setting file of FIG. 13 writes the same information in both the normal area and the duplicated area defined by the area commands. The writing of the same information in a plurality of areas can improve the safety of information.

In the setting file of FIG. 13, a normal area for billing information is allocated to the resident NVRAM area, and a duplicated area for the billing information is allocated to the optional NVRAM area, thereby enhancing the safety of information. In this case, it is preferable to provide the resident NVRAM area and the optional NVRAM area in separate NVRAMs in consideration of safety against the erasure of information or the like. In the setting file of FIG. 13, information is duplicated and stored in separate areas. By the same token, information may be stored in three or more separate areas.

[Fourth Embodiment]

An image-processing device, for example, is generally configured to accept various controller boards such as a controller board conforming to basic functions, a controller board conforming to basic functions plus optional functions, etc. In such image-processing device for which various controller boards are provided for various function combinations, the exchanging of controller boards makes it possible to add or delete desired functions.

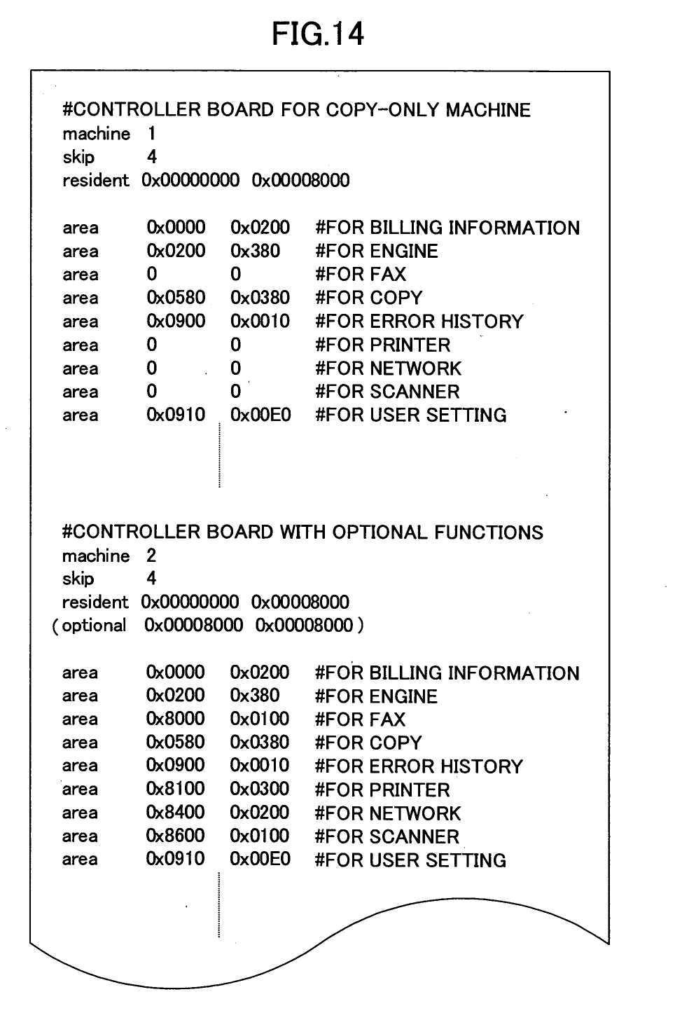

In this case, model-type-dependent information for all the available controller boards may be described in a setting file, so that mere exchanging of controller boards makes it possible to add or delete desired functions without modifying the description of the setting file. FIG. 14 is an illustrative drawing showing an example of a setting file usable for a plurality of controller boards. The machine command on the second line specifies model-type information for identifying a controller board.

In the setting file of FIG. 14, the model-type-dependent information corresponding to the machine command having the model-type information “1” is model-type-dependent information about a controller board conforming to basic functions. Further, the model-type-dependent information corresponding to the machine command having the model-type information “2” is model-type-dependent information about a controller board conforming to basic functions plus optional functions. In the setting file of FIG. 14, the facsimile function, the printer function, the network function, and the scanner function constitute optional functions.

As shown in the setting file of FIG. 14, the resident NVRAM area may be allocated to the basic functions whereas the optional NVRAM area may be allocated to the optional functions. This achieves the clear compartmentalization of the basic functions and the optional functions.

[Fifth Embodiment]

In the first through fourth embodiments described above, model-type-dependent information needs to be described in the single setting file 52. The fifth embodiment is directed to a device control method in which model-type-dependent information is provided as separate descriptions contained in a plurality of respective files.

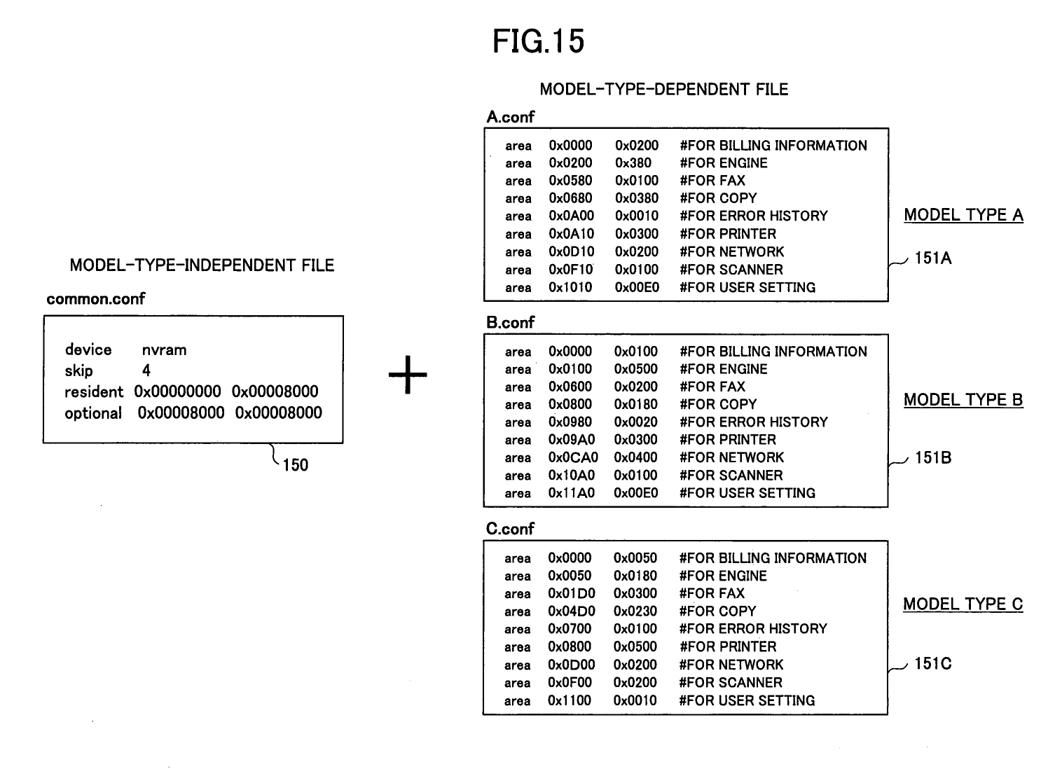

FIG. 15 is an illustrative drawing showing an example of a setting file in which model-type-dependent information is divided into separate descriptions contained in a plurality of respective files. The setting file of FIG. 15 includes a model-type-independent file 150 containing a description of model-type-independent information that is shared regardless of model types, and further includes model-type-dependent files 151A through 151C containing respective descriptions of model-type-dependent information that is model-specific.

The model-type-independent file 150 includes cone command together with one or more associated parameters per line. Each command is the same as in the first through fourth embodiments described above, and a description thereof will be omitted as appropriate. In the model-type-independent file 150 shown in FIG. 15, the first line is a device command, which specifies the NVRAM 15. The second line is a skip command, which specifies the type of bus connection.

The third line of the model-type-independent file 150 is a resident command, which specifies the resident NVRAM area by using an offset from the start address and its size. The fourth line of the model-type-independent file 150 is an optional command, which specifies the optional NVRAM area by use of an offset from the start address and its size.

The model-type-dependent files 151A through 151C correspond to model types A through C. Each line includes one command together with one or more associated parameters. In the model-type-dependent files 151A through 151C shown in FIG. 15, the first through nines lines are area commands, which specify the respective usage-specific divided areas of the NVRAM 15 by using offsets from the start address of the NVRAM 15 and their respective sizes. Further, the area command may include a parameter for indicating area identification information that serves to identify a corresponding area of the NVRAM 15 among areas divided according to usages.

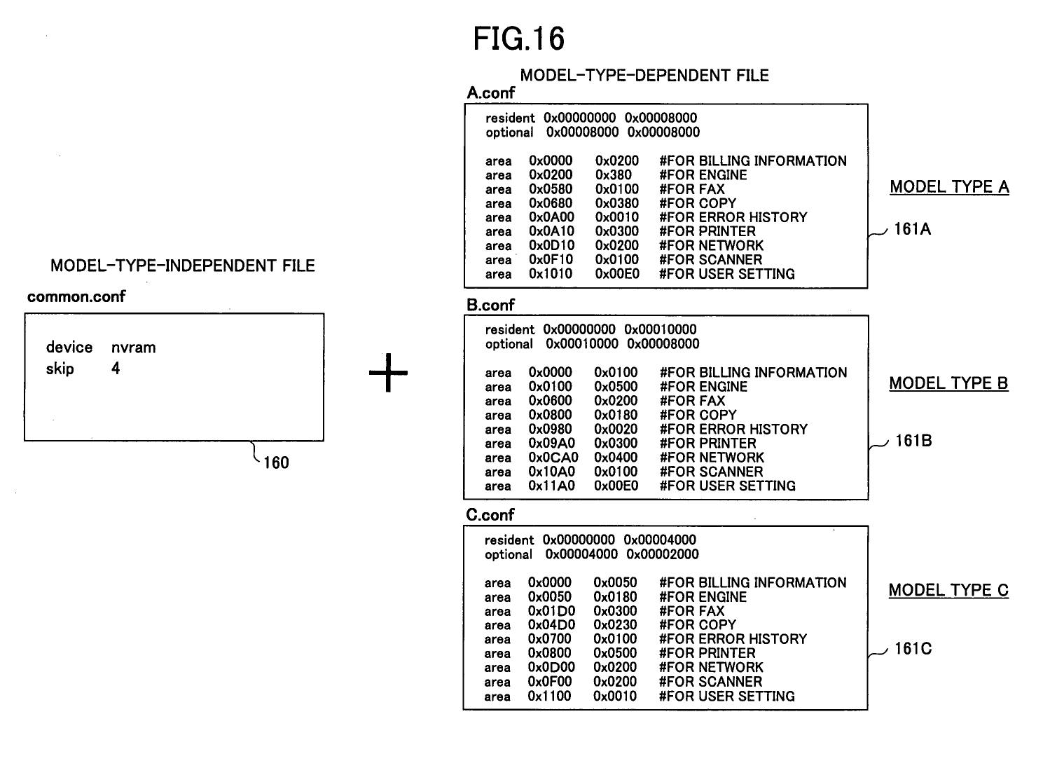

The model-type-dependent information may be divided into separate descriptions as shown in FIG. 16. FIG. 16 is an illustrative drawing showing another example of a setting file in which model-type-dependent information is divided into separate descriptions. The setting file of FIG. 16 differs from the setting file of FIG. 15 in that the resident command and the optional command are contained in model-type-dependent files 161A through 161C rather than in a model-type-independent file 160.

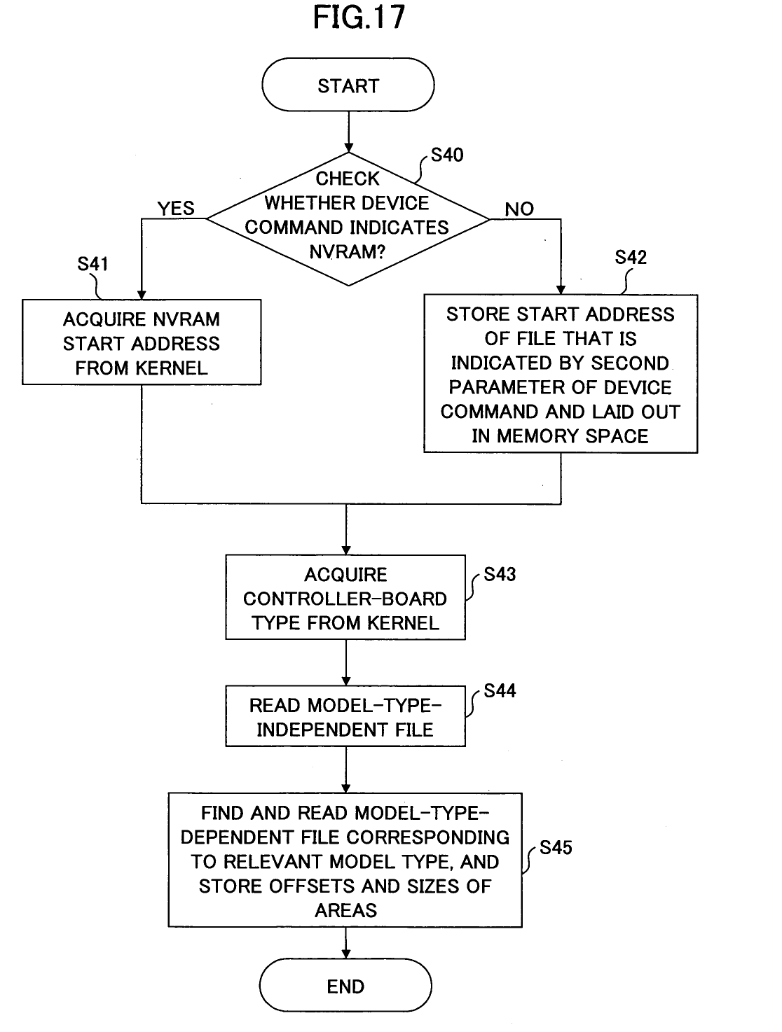

In the following, a description will be given of, with reference to FIG. 17, a process performed by the device control library to read the setting file of FIG. 15. A process performed by the device control library to read the setting file of FIG. 16 is the same as the process performed by the device control library to read the setting file of FIG. 15, and a description thereof will be omitted. FIG. 17 is a flowchart showing an example of a process carried out by the device control library to read a setting file. The setting-file reading process of FIG. 16 is similar to the setting-file reading process of FIG. 8, and a description thereof will be omitted as appropriate.

Steps S40 through S43 are the same as steps S10 through S13 of FIG. 8. At step S44, the device control library 51 reads the model-type-independent file 150. At step S45, the device control library 51 uses the obtained model-type information to search in the model-type-dependent files 151A through 1151C to read model-type-dependent information corresponding to the indicated model type, followed by storing the offsets and sizes of the usage-specific divided areas of the NVRAM 15.

When a process on the model type A accesses the NVRAM 15, for example, the device control library 51 reads the model-type-independent file 150 and the model-type-dependent file 151 A, and stores the offsets and sizes of the usage-specific divided areas of the NVRAM 15. The process running on the OS then accesses the NVRAM 15 by the device accessing procedure of FIG. 9.

In the device control method according to at least one embodiment of the invention described above, the model-type-dependent information is divided into separate descriptions, which are stored in one model-type-independent file and a plurality of model-type-dependent files. All that is necessary to allow the device control library 51 to cope with a different or new model type is to modify the model-type-dependent files.

[Sixth Embodiment]

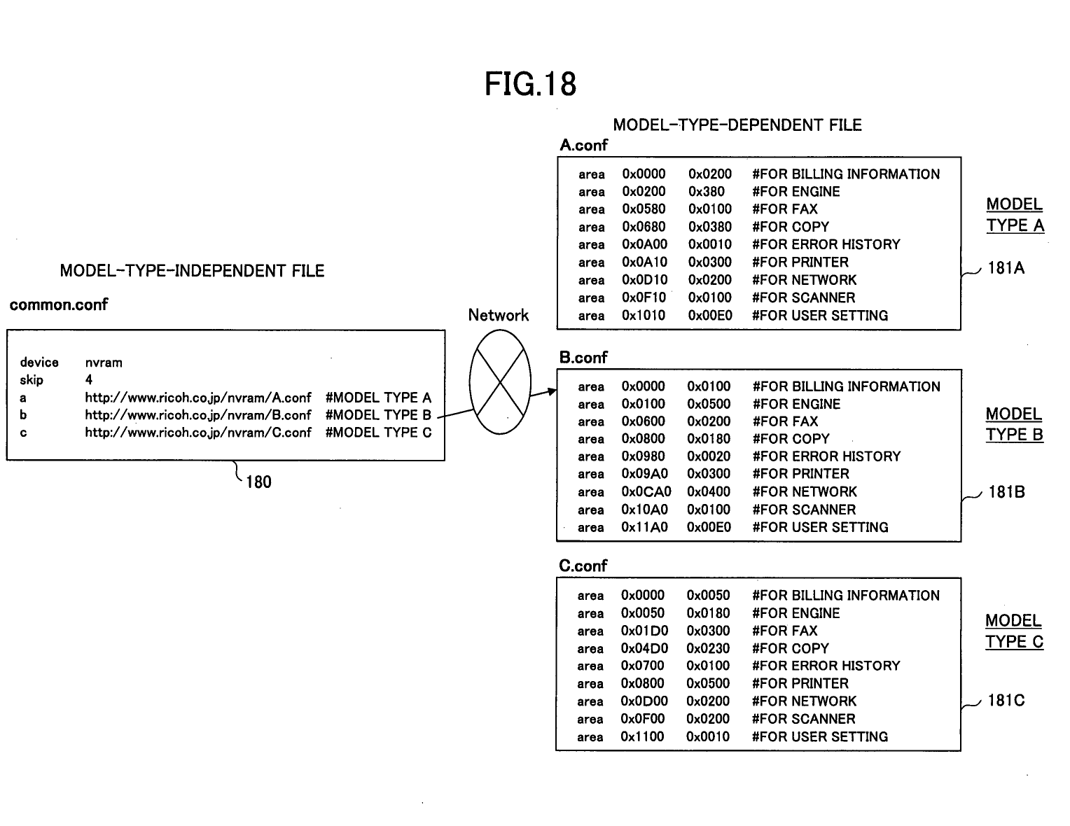

In the sixth embodiment, model-type-dependent information is divided into one model-type-independent file and a plurality of model-type-dependent files, and the plurality of model-type-dependent files are stored in the server 110 on the network 100. FIG. 18 is an illustrative drawing showing an example of a setting file that is used when model-type-dependent files are acquired from a server. The setting file of FIG. 18 includes a model-type-independent file 180 containing a description of model-type-independent information, and further includes model-type-dependent files 181A through 181C containing respective descriptions of model-type-dependent information that is model-specific.

The model-type-independent file 180 includes cone command together with one or more associated parameters per line. Each command is the same as in the first through fourth embodiments described above, and a description thereof will be omitted as appropriate. In the model-type-independent file 180 shown in FIG. 18, the first line is a device command, which specifies the NVRAM 15. The second line is a skip command, which specifies the type of bus connection.

The third through fifth lines of the model-type-independent file 180 include the descriptions of URLs of the model-type-dependent files 181A through 181C corresponding to the model types A through C. With this provision, the device control library 51 accesses the URL of a relevant model type to retrieve one of the model-type-dependent files 181A through 181C. The construction of the model-type-dependent files 181A through 181C is the same as that of the model-type-dependent files 151A through 151C.

In the device control method according to at least one embodiment of the invention described above, a plurality of model-type-dependent files are stored in the server 110 on the network 100. This makes it possible to dynamically change the model-type-dependent information.

[Seventh Embodiment]

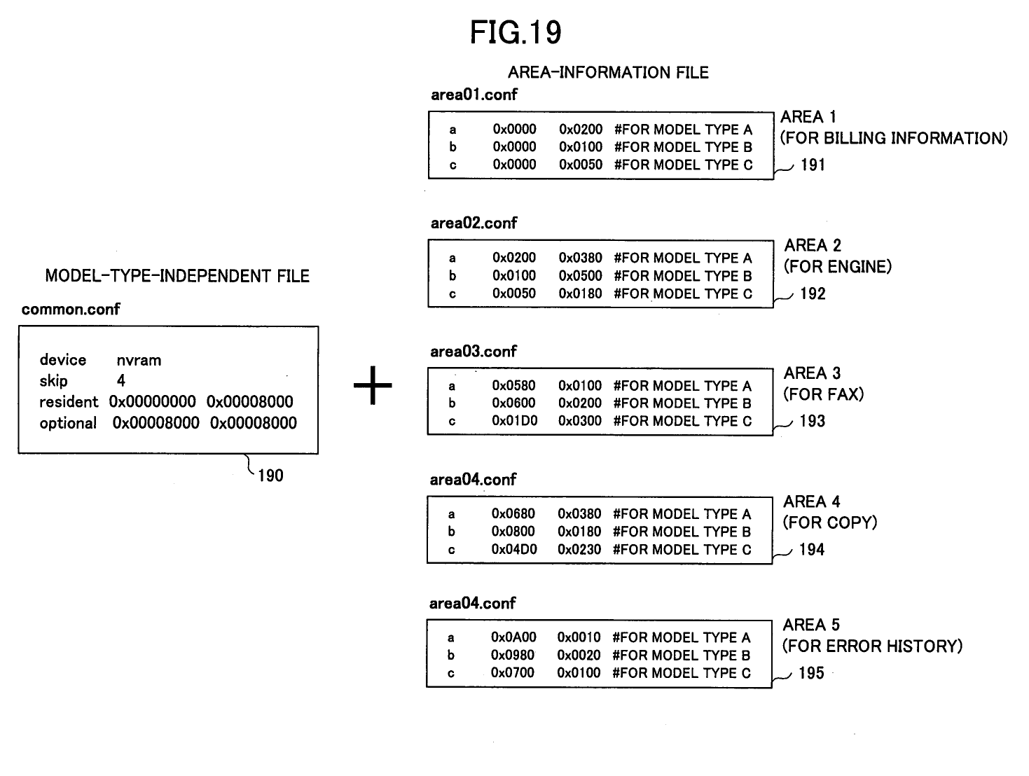

The seventh embodiment is directed to another device control method in which model-type-dependent information is divided into separate descriptions contained in respective files. FIG. 19 is an illustrative drawing showing another example of a setting file in which model-type-dependent information is divided into separate descriptions contained in respective files. The setting file of FIG. 19 includes a model-type-independent file 190 and area information files 191 through 195 that contain respective descriptions of model-type-dependent information separately for usage-specific divided areas.

The model-type-independent file 190 is the same as the model-type-independent file 150 of FIG. 15. The area information files 191 through 195 are provided separately for the respective usage-specific divided areas of the NVRAM 15 (e.g., for the billing-information purpose, for the engine purpose, and the like). Each of the area information files 191 through 195 specifies the areas of the NVRAM 15 corresponding to respective model types by using offsets from the start address of the NVRAM 15 and their respective sizes. This provides for the areas of the NVRAM 15 corresponding to respective model types to be readily compared.

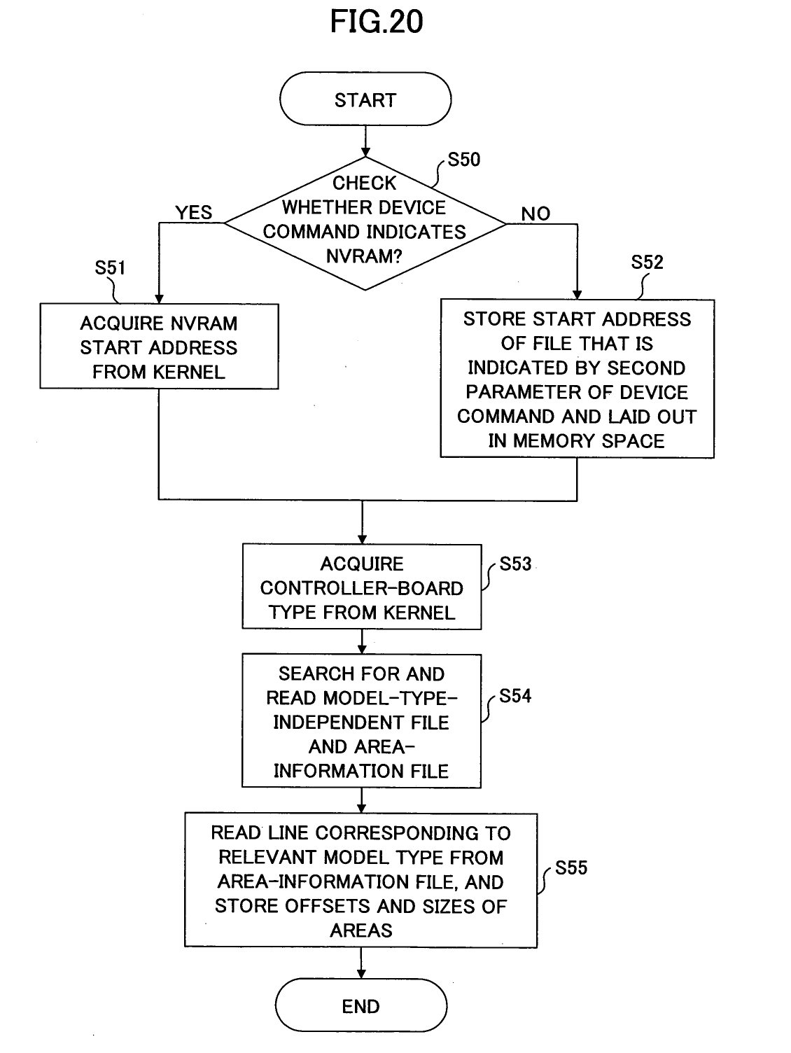

In the following, a description will be given of, with reference to FIG. 20, a process performed by the device control library to read the setting file of FIG. 19. FIG. 20 is a flowchart showing another example of a process carried out by the device control library to read a setting file. The setting-file reading process of FIG. 20 is similar to the setting-file reading process of FIG. 8, and a description thereof will be omitted as appropriate.

Steps S50 through S53 are the same as steps S10 through S13 of FIG. 8. At step S54, the device control library 51 reads the model-type-independent file 190, followed by identifying and reading one of the area information files 191 through 195 corresponding to the area to be accessed. If a process on the model type C accesses a copy-purpose area of the NVRAM 15, the device control library 51 reads the model-type-independent file 190 and the area information file 194.

At step S55, the device control library 51 uses the obtained model-type information to read a line from the retrieved area information file where this line corresponds to the indicated model type, followed by storing the offset and size of the relevant usage-specific divided area of the NVRAM 15.

When a process on the model type C accesses a copy-purpose area of the NVRAM 15, for example, the device control library 51 reads the third line of the area information file 194, and stores the offset “0x04D0” and size “0x0230” of the copy-purpose area. The process running on the OS then accesses the NVRAM 15 by the device accessing procedure of FIG. 9.

In the device control method according to at least one embodiment of the invention described above, the model-type-dependent information is divided into separate descriptions, which are stored in one model-type-independent file and a plurality of area information files. All that is necessary to allow the device control library 51 to cope with a different or new model type is to modify the area information files.

Further, the present invention is not limited to these embodiments, but various variations and modifications may be made without departing from the scope of the present invention.

The present application is based on Japanese priority application No. 2003-187692 filed on Jun. 30, 2003, with the Japanese Patent Office, the entire contents of which are hereby incorporated by reference.

1. An information processing device in which one or more programs use one or more devices, comprising a device controlling unit linkable to said one or more programs and configured to read one or more setting files containing model-type-dependent information provided separately for one or more model types and to control said one or more devices in response to a request from said one or more programs in accordance with the model-type-dependent information corresponding to a model type of said information processing device.

2. The information processing device as claimed in claim 1, wherein said device controlling unit configured to read said one or more setting files that are separate from said device controlling unit.

3. The information processing device as claimed in claim 1, wherein said device controlling unit controls a nonvolatile memory device as said one or more devices, said nonvolatile memory device being used with an area thereof being divided on a usage-specific basis.

4. The information processing device as claimed in claim 3, wherein said device controlling unit uses, as said model-type-dependent information, model-type information indicative of a model type, device-area information indicative of an area of said nonvolatile memory device, and usage-specific-area information indicative of areas divided on a usage-specific basis.

5. The information processing device as claimed in claim 1, wherein said device controlling unit controls said one or more devices in response to a request from said one or more programs in accordance with the model-type-dependent information corresponding to respective device types of said one or more devices as well as the model type of said information processing device.

6. The information processing device as claimed in claim 1, wherein said device controlling unit configured to read, as said one or more setting files, one or more model-type-dependent files containing the model-type-dependent information provided separately for one or more model types and a model-type-independent file containing model-type-independent information that is independent of the model types.

7. The information processing device as claimed in claim 6, wherein said device controlling unit is configured to read the one or more model-type-dependent files containing usage-specific area information indicative of areas divided according to usages, and to read the model-type-independent file containing device-type information indicative of one or more device types and device-area information indicative of areas provided by said one or more devices.

8. The information processing device as claimed in claim 6, wherein said device controlling unit is configured to read the one or more model-type-dependent files containing usage-specific area information indicative of areas divided according to usages and device-area information indicative of areas provided by said one or more devices, and to read the model-type-independent file containing device-type information indicative of one or more device types.

9. The information processing device as claimed in claim 1, wherein said device controlling unit configured to read, as said one or more setting files, one or more area-information files containing the model-type-dependent information separately for respective usages and a model-type-independent file containing model-type-independent information that is independent of the model types.

10. The information processing device as claimed in claim 9, wherein said device controlling unit is configured to read the model-type-independent file containing device-type information indicative of one or more device types and device-area information indicative of areas provided by said one or more devices.

11. The information processing device as claimed in claim 1, wherein said device controlling unit configured to read, as said one or more setting files, at least one of one or more model-type-dependent files containing the model-type-dependent information provided separately for one or more model types and a model-type-independent file containing model-type-independent information that is independent of the model types, wherein at least one of said one or more model-type-dependent files and said model-type-independent file is read through a network.

12. The information processing device as claimed in claim 1, wherein said device controlling unit is configured to use, as the model-type-dependent information, usage-specific area information indicative of areas divided according to usages, said usage-specific area information including offsets from a start of an area provided by said one or more devices and sizes of the divided areas.

13. The information processing device as claimed in claim 4, wherein said device controlling unit is configured to use the usage-specific area information that indicates normal areas divided according to usages and duplicated areas divided according to the usages, and is configured to store common data in the normal areas and the duplicated areas of said nonvolatile memory device.

14. The information processing device as claimed in claim 13, wherein said device controlling unit is configured to store common data in the normal areas of one of said nonvolatile memory device and in the duplicate areas of another one of said nonvolatile memory device.

15. The information processing device as claimed in claim 13, wherein said device controlling unit is configured to store common billing information in the normal areas of one of said nonvolatile memory device and in the duplicate areas of another one of said nonvolatile memory device.

16. The information processing device as claimed in claim 1, wherein said device controlling unit is configured to acquire model-type information indicative of the model type of said information processing device from an operating system, and is configured to control said one or more devices in response to a request from said one or more programs in accordance with the model-type-dependent information corresponding to the acquired model type of said information processing device.

17. The information processing device as claimed in claim 1, wherein said device controlling unit is a library.

18. The information processing device as claimed in claim 1, wherein said device controlling unit is configured to control said one or more devices in response to a request from the one or more programs for forming an image.

19. A method of controlling one or more devices in an information processing device in which one or more programs use the one or more devices, comprising the steps of:
utilizing a device controlling unit linkable to said one or more programs to read one or more setting files containing model-type-dependent information provided separately for one or more model types; and
utilizing said device controlling unit to control said one or more devices in response to a request from said one or more programs in accordance with the model-type-dependent information corresponding to a model type of said information processing device.

20. A computer-readable medium having a program embodied therein for causing a computer to control one or more devices, said program comprising a device controlling unit linkable to one or more programs and configured to read one or more setting files containing model-type-dependent information provided separately for one or more model types and to control said one or more devices in response to a request from said one or more programs in accordance with the model-type-dependent information corresponding to a model type of said information processing device.
